(19) United States
(12) Patent Application Publication
(10) Pub. No.: US 2005/0205716 A1
(43) Pub. Date: Sep. 22, 2005

(54) Stealth craft

(76) Inventor: Jakob Bjerkemo, Linkoping (SE)

Correspondence Address: David M Carter;Carter DeLuca Farrell & Schmidt, 445 Boadhollow Road, Suite 225, Melville, NY, 11747, US

(21) Appl. No.: 10/511,650

(22) PCT Filed: Apr. 30, 2003
(86) PCT No.: PCT/SE03/00705

§ 371 Date: Oct. 18, 2004

(30) Foreign Application Priority Data
May 15, 2002 (SE) 0201460-3

(51) Int. Cl. B64C 1/00

(52) U.S. Cl. 244/119

(57) ABSTRACT

The invention relates to a stealth craft having several essentially plane external surfaces (13a-d), at least some of these external surfaces being arranged to incline towards each other so as to meet in an outer edge (12). The outer edge (12) is divided into at least a first outer edge section (12a) and a second outer edge section (12b), which first and second outer edge sections (12a, 12b) extend along a respective essentially straight line as seen in a lateral view of the craft, at least one part of the first outer edge section (12a) and one part of the second outer edge section (12b) forming part of an outer periphery line (18) of the craft as seen in a planar view of the craft from the upside or underside of the craft. A first point (16a) of the first outer edge section (12a) is connected to a second point (16b) of the second outer edge section (12b) via a fold (17) arranged in the exterior of the craft, said points (16a, 16b) being located on mutually different levels as seen in a direction perpendicular to said planar view.

### FIELD OF THE INVENTION AND PRIOR ART

The present invention relates to a stealth craft according to the preamble of claim 1. The invention particularly relates to a stealth craft in the form of an aircraft.

In the design of stealth crafts the exterior of the aircraft is normally designed, to the utmost possible extent, with plane external surfaces which incline as much as possible in relation to a vertical plane. This owing to that a surface gives a strong radar echo in the direction of the perpendicular of the surface. By arranging the external surfaces with an inclination in the above-mentioned manner, the radar echo caused by the aircraft when it comes within the reach for radar waves from a radar station is reduced. The stealth aircraft is normally provided with an outer edge line, a waistline, which runs around the aircraft. From this waistline, plane external surfaces incline, on each side of the waistline, inwards towards the vertical centre plane of the aircraft. A stealth aircraft of this type is previously known for instance from the patent U.S. Pat. No. 5,250,950 A.

In order to obtain as good stealth characteristics as possible in a stealth aircraft, the main wings of the aircraft and possible stabilizers and/or nose wings are arranged in such a manner that their outer edges coincide with a waistline of the above-mentioned type. A disadvantage with this known solution is that the main wings, the stabilizers and the nose wings of the aircraft will be located essentially in one and the same plane, which does not give an optimal aerodynamic design of the aircraft. In this type of stealth aircraft, it has been necessary to lower the standards of aerodynamical characteristics in favour of the stealth characteristics.

### OBJECT OF THE INVENTION

The object of the present invention is to make possible a larger flexibility in the design of a stealth craft, and particularly to make possible an elimination of the above-mentioned disadvantages in a stealth aircraft while maintaining good stealth characteristics.

### SUMMARY OF THE INVENTION

According to the invention, said object is achieved by means of a stealth craft having the features defined in claim 1. The stealth craft according to the invention is characterised in that an outer edge of the craft is divided into at least a first outer edge section and a second outer edge section, which first and second outer edge sections extend along a respective essentially straight line as seen in a lateral view of the craft, at least one part of the first outer edge section and one part of the second outer edge section forming part of an outer periphery line of the craft as seen in a planar view of the craft from the upside or underside of the craft, and that a first point of the first outer edge section is connected to a second point of the second outer edge section via a fold arranged in the exterior of the craft, said points being located on mutually different levels as seen in a direction perpendicular to said planar view.

The solution according to the invention implies that said outer periphery line of the stealth craft will comprise sections extending in mutually different planes. This will for instance make it possible to pay regard to the aerodynamical characteristics to a larger extent in the design of a stealth aircraft with maintenance of good stealth characteristics.

According to a preferred embodiment of the invention, the angle between the fold and the first outer edge section and also the angle between the fold and the second outer edge section is acute, as seen in a lateral view of the craft. Hereby, the first outer edge section, the second outer edge section and the fold will, as seen in a lateral view of the craft, together have a Z-like shape in the zone for the transition from the first outer edge section to the second outer edge section. Hereby, it will be possible to achieve a large level increase in the outer edge in question, i.e. a large level difference between the first outer edge section and the second outer edge section, on a short distance along the craft. Said Z-shape will also give the zone in question of the craft a favourable streamline shape.

According to a particularly preferred embodiment of the invention, the craft constitutes an aircraft, which comprises a main wing, the outer edge of which forms part of the first outer edge section, and a nose wing or stabilizer, the outer edge of which forms part of the second outer edge section. A stealth aircraft designed in this manner may, in comparison with stealth aircrafts according to prior art, be given improved aerodynamical characteristics with maintained or only insignificantly deteriorated stealth characteristics.

Further preferred embodiments of the stealth craft according to the invention will appear from the dependent claims and the subsequent description.

The solution according to the invention is also applicable to other types of stealth crafts than aircrafts, such as for instance to ships, vehicles and airborne missiles.

### BRIEF DESCRIPTION OF THE DRAWINGS

The invention will in the following be more closely described by means of embodiment examples, with reference to the appended drawings. It is shown in:

FIG. 1 a schematical perspective view from above of a stealth aircraft according to prior art,

FIG. 2 a schematical perspective view from below of the stealth aircraft according to FIG. 1,

FIG. 3 a schematical perspective view of a stealth aircraft designed in accordance with the invention,

FIG. 4 a planar view from above of the stealth aircraft according to FIG. 3,

FIG. 5 a schematical perspective view of a part of a stealth aircraft designed in accordance with the invention, illustrating the arrangement of a nose wing and a main wing on mutually different levels,

FIG. 6 a schematical perspective view of a part of a stealth aircraft designed in accordance with the invention, illustrating the arrangement of a main wing and a stabilizer on mutually different levels,

FIG. 7 a very schematical lateral view of a part of a stealth craft designed in accordance with the invention, and

FIG. 8 a very schematical lateral view of an alternative design of a part of a stealth craft designed in accordance with the invention.

### DETAILED DESCRIPTION OF PREFERRED EMBODIMENTS

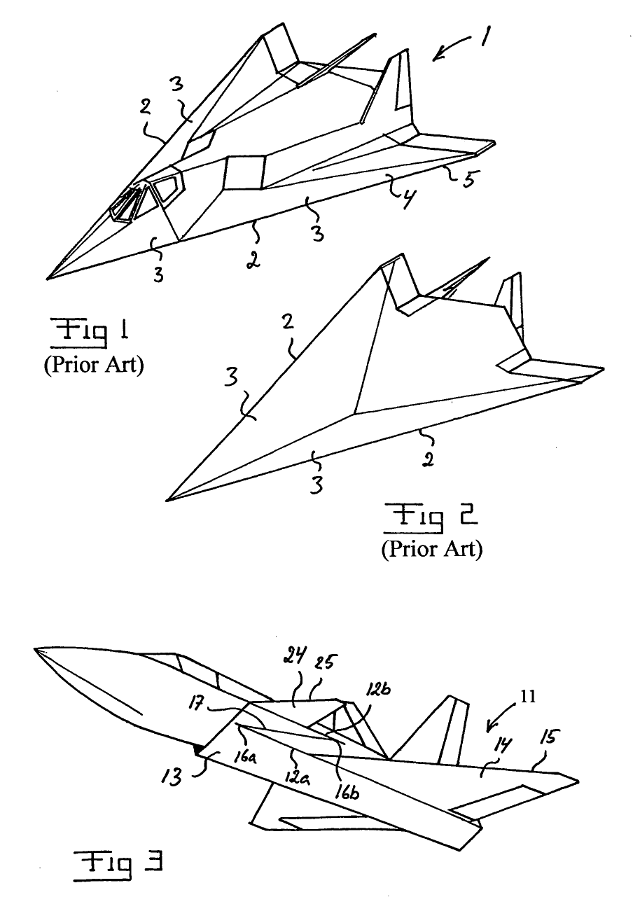

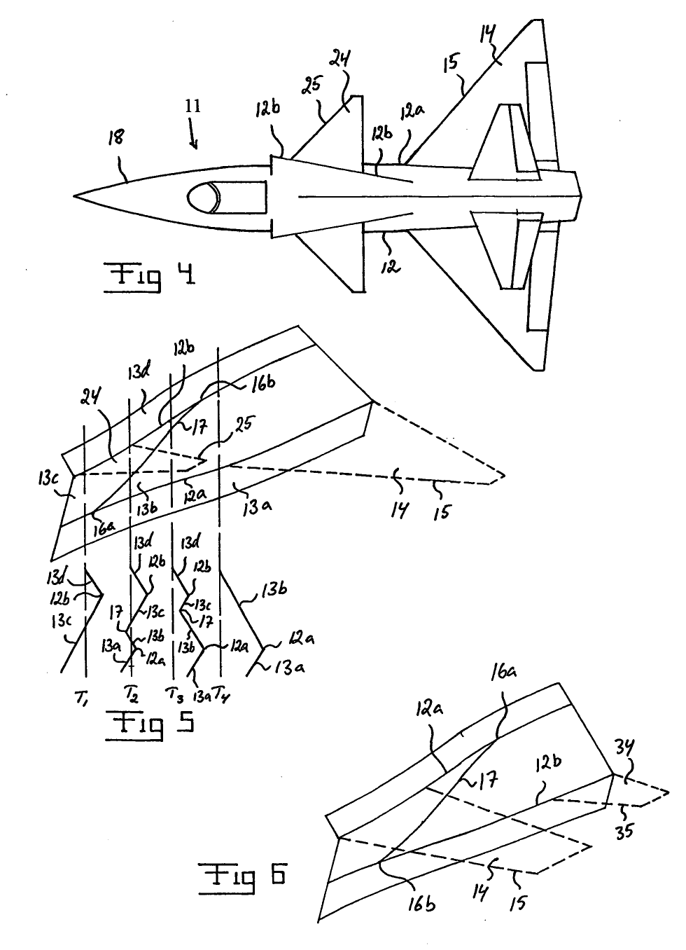

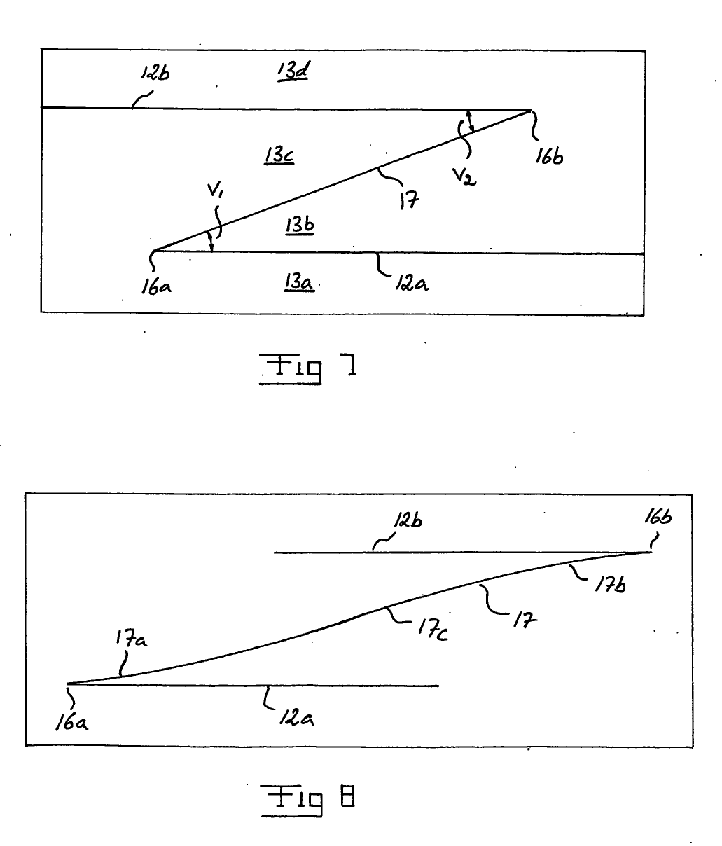

In FIGS. 1 and 2, a stealth aircraft 1 according to prior art is illustrated, more precisely of the type described in U.S. Pat. No. 5,250,950 A. The aircraft 1 has here a waistline 2 running around the aircraft and which constitutes an outer periphery line of the aircraft as seen in a planar view of the aircraft from the upside or underside thereof. This waistline 2 extends essentially in one and the same plane. From this waistline 2, plane external surfaces 3 incline inwards towards the vertical centre plane of the aircraft. This known stealth aircraft has a delta wing 4, the outer edge 5 of which forming part of the waistline 2.

In this description and the subsequent claims, the expression “external surface” refers to an outside surface of the craft. The expression “outer edge” refers to an edge, protruding on the exterior of the craft, between external surfaces that are adjacent to each other.

In FIGS. 3 and 4, a stealth craft 11 according to the present invention is illustrated. The craft here constitutes a stealth aircraft.

The stealth craft 11 according to the invention has several plane or at least essentially plane external surfaces 13, at least some of which being arranged to incline towards each other so as to meet in an outer edge 12, which is arranged to run along and on the exterior of the craft. This outer edge 12 can be considered to correspond to the waistline 2 of the stealth aircraft illustrated in FIGS. 1 and 2. The outer edge 12 is divided into at least a first outer edge section 12a and a second outer edge section 12b, which extend along a respective essentially straight line as seen in a lateral view of the craft. At least one part of the first outer edge section 12a and one part of the second outer edge section 12b form part of an outer periphery line of the craft as seen in a planar view of the craft from the upside or underside of the craft. According to the invention, a first point 16a of the first outer edge section 12a is connected to a second point 16b of the second outer edge section 12b via a fold 17 arranged in the exterior of the craft, said points 16a, 16b being located on mutually different levels as seen in a direction perpendicular to said planar view. Hereby, a “waistline” is achieved, which runs in several different planes. As will be more closely described in the following, the fold 17 is formed by external surfaces inclining towards each other, a first external surface 13b extending between the fold 17 and the first outer edge section 12a and a second external surface 13c extending between the fold 17 and the second outer edge section 12b. Said first and second external surfaces 13b, 13a abut against each other in the fold 17.

In FIG. 7, a part of a stealth craft designed in accordance with the invention, as seen in a lateral view of the craft, is illustrated very schematically. An outer edge extends across the part illustrated in FIG. 7, which outer edge in the above-indicated manner is divided into a first outer edge section 12a and a second outer edge section 12b, which in the shown lateral view extend along a respective straight or at least essentially straight line. A fold 17 arranged in the exterior of the craft connects a first point 16a of the first outer edge section 12a with a second point 16b of the second outer edge section 12b. These points may constitute end points of the respective outer edge section.

The fold 17 may be arranged to extend along a straight or at least essentially straight line as seen in a lateral view of the craft, as illustrated in FIG. 7. From the first outer edge section 12a, a plane or at least essentially plane external surface 13a, 13b inclines on each side of the outer edge section 12a obliquely inwards towards the vertical centre plane of the craft. One 13b of these external surfaces extends between the first outer edge section 12a and the fold 17. From the second outer edge section 12b, a plane or at least essentially plane external surface 13c, 13d likewise inclines on each side of the outer edge section 12b obliquely inwards towards the vertical centre plane of the craft. One 13c of these external surfaces extends between the second outer edge section 12b and the fold 17. The external surfaces 13b and 13c consequently incline inwards towards the fold 17 and meet each other in this fold.

Preferably, the angle v₁ between the fold 17 and the first outer edge section 12a, as well as the angle v₂ between the fold 17 and the second outer edge section 12b, is acute, as seen in a lateral view of the craft. Consequently, these angles v₁, v₂ preferably are larger than 0° and smaller than 90°. When the fold 17 is arranged to extend along a straight or at least essentially straight line as seen in a lateral view of the craft, as illustrated in FIG. 7, said angles v₁, v₂ suitably are in the interval 10-80°.

In an application of the invention at a stealth aircraft, the fold 17 suitably has a design of the type illustrated in FIG. 8. In FIG. 8, a part of a stealth aircraft designed in accordance with the invention is illustrated very schematically, as seen in a lateral view of the craft. An outer edge extends across the part illustrated in FIG. 8, which outer edge in the above-indicated manner is divided into a first outer edge section 12a and a second outer edge section 12b, which in the shown lateral view extend along a respective straight or at least essentially straight line. The fold 17 that connects a first point 16a of the first outer edge section 12a to a second point 16b of the second outer edge section 12b here has a tangential connection to the respective outer edge section 12a, 12b via an end part 17a, 17b of the fold having a slightly rounded shape, as seen in a lateral view. The respective end part 17a, 17b here has such a rounding that the associated outer edge section 12a, 12b forms, or at least nearly forms, a tangent to the end part 17a, 17b, as seen in a lateral view. The two end parts 17a, 17b are connected to each other via a centre part 17c of the fold, which centre part is softly curve-shaped, as seen in a lateral view. In this case, the angle between the fold 17 and the respective outer edge section 12a, 12b is consequently, as seen in a lateral view, very small in the vicinity of the respective connection point 16a, 16b and then increases towards the centre of the fold. This curve-shaped design of the fold 17 gives the aircraft part in question favourable aerodynamical characteristics.

Cross-sectional profiles T₁-T₄ at different locations in a zone of a stealth craft where a first outer edge section 12a is connected to a second outer edge section 12b via a fold 17 are shown in the lower part of FIG. 5. As appears from these cross-sectional profiles, the external surfaces 13a and 13b, which incline towards each other, will in the zone for the first outer edge section 12a together form a surface section which, as seen in a cross-section through the craft, has a V-shape, the first outer edge section 12a constituting an outwardly facing apex of such a V-shaped surface section. In the same manner, the external surfaces 13c and 13d, which incline towards each other, will in the zone for the second outer edge section 12b together form a surface section which, as seen in a cross-section through the craft, has a V-shape, the second outer edge section 12b constituting an outwardly facing apex of such a V-shaped surface section. The external surfaces 13b and 13c, which incline towards each other, will in the zone for the fold 17 together form a surface section which, as seen in a cross-section through the craft, has a V-shape, the fold 17 constituting an inwardly facing apex of such a V-shaped surface section.

In the embodiment illustrated in FIGS. 3 and 4, the stealth aircraft 5 comprises a main wing 14, the outer edge 15 of which forming part of the first outer edge section 12a, and a nose wing 24, the outer edge 25 of which forming part of the second outer edge section 12b. This arrangement of the main wing 14 and the nose wing 24 on different levels is also illustrated in FIG. 5. The nose wing 24 is here arranged on a level above the main wing 14, as seen in a lateral view of the aircraft. In FIG. 5, the main wing 14 and the nose wing 24 are marked with broken lines.

In the corresponding manner, a stealth aircraft according to the invention may comprise a main wing 14, the outer edge 15 of which forming part of a first outer edge section 12a, and a stabilizer 34, the outer edge 35 of which forming part of a second outer edge section 12b, as schematically illustrated in FIG. 6. In FIG. 6, the main wing 14 and the stabilizer 34 are marked with broken lines. The stabilizer 34 is here arranged on a level below the main wing 14, as seen in a lateral view of the aircraft, and the fold 17 is here, consequently, arranged to connect a point 16a of the first outer edge section 12a with a point 16b of the second outer edge section 12b located on a lower level.

The outer edge 12 of a stealth craft according to the invention may of course be divided into more than two outer edge sections, which are mutually connected via folds 17 of the above-described type. For instance, a stealth aircraft according to the invention may comprise a main wing 14, the outer edge 15 of which forming part of a first outer edge section, a nose wing 24, the outer edge 25 of which forming part of a second outer edge section, and a stabilizer 34, the outer edge 35 of which forming part of a third outer edge section, where the different outer edge sections are located on mutually different levels as seen in a lateral view of the aircraft and where the first outer edge section is connected to the second outer edge section via a first fold and to the third outer edge section via a second fold.

With the solution according to the invention, a V-tail may also be located on a level above the main wings of a stealth aircraft.

In FIG. 4, a stealth craft according to the invention, as seen from above, is shown. In this planar view, the above-mentioned outer periphery line of the craft appears. This outer periphery line 18 corresponds to the contour of a planar projection of the craft. As appears from FIG. 4, a part of the first outer edge section 12a as well as a part of the second outer edge section 12b form part of the outer periphery line 18 of the illustrated stealth aircraft.

Likewise, the outer edges 15 of the main wings 14 and the outer edges 25 of the nose wings 24 form part of said periphery line 18.

The invention is of course not in any way limited to the preferred embodiments described above, on the contrary several possibilities to modifications thereof should be apparent to a person skilled in the art, without thereby deviating from the basic idea of the invention as defined in the appended claims. In an application of the invention in a stealth aircraft, it may for instance be suitable to arrange an air intake or an air outlet directly in connection to the zone where the fold 17 connects to an outer edge section 12a, 12b.

The invention has above been exemplified in the form of a stealth aircraft. The solution according to the invention is however also applicable to other types of stealth crafts than aircrafts. The stealth craft according to the invention may for instance constitute a ship, a vehicle or an airborne missile.

1. A stealth craft having several essentially plane external surfaces, at least some of these external surfaces being arranged to incline towards each other so as to meet in an outer edge, characterized in that the outer edge is divided into at least a first outer edge section and a second outer edge section, which first and second outer edge sections extend along a respective essentially straight line as seen in a lateral view of the craft, at least one part of the first outer edge section and one part of the second outer edge section forming part of an outer periphery line of the craft as seen in a planar view of the craft from the upside or underside of the craft, and that a first point of the first outer edge section is connected to a second point of the second outer section via a fold arranged in the exterior of the craft, said points being located on mutually different levels as seen in a direction perpendicular to said planar view.

2. A stealth craft according to claim 1, characterized in that the a first angle between the fold and the first outer edge section is acute, as seen in a lateral view of the craft, and that a second angle between the fold and the second outer edge section also is acute, as seen in a lateral view of the craft.

3. A stealth craft according to claim 1, characterized in that the craft constitutes an aircraft.

4. A stealth craft according to claim 3, characterized in that the craft comprises a main wing, an outer edge of which forming of the first outer edge section.

5. A stealth craft according to claim 4, characterized in that the craft comprises a nose wing, an outer edge of which forming part of the second outer edge section.

6. A stealth craft according to claim 4, characterized in that the craft comprises a stabilizer, an outer edge of which forming part of the second outer edge section.

7. A stealth craft according to claim 2, characterized in that the craft constitutes an aircraft.

8. A stealth craft according to claim 7, characterized in that the craft comprises a main wing, an outer edge of which forming of the first outer edge section.

9. A stealth craft according to claim 8, characterized in that the craft comprises a nose wing, an outer edge of which forming part of the second outer edge section.

10. A stealth craft according to claim 8, characterized in that the craft comprises a stabilizer, an outer edge of which forming part of the second outer edge section.

11. A stealth craft comprising:
a plurality of surfaces disposed on an external surface of the stealth craft wherein at least one surface is oriented towards at least one other surface thereby forming at least one outer edge, the at least one outer edge including first and second outer edge sections;
an outer periphery line extending along at least a portion of the stealth craft wherein at least a portion of the outer periphery line is formed by the first and second outer edge sections;
a first point located on one end of the first outer edge section and a second point located on one end of the second outer edge section; and
a fold disposed on an exterior of the stealth craft extending between the first and second points wherein the first point is laterally and longitudinally spaced apart from the second point.

12. The stealth craft of claim 11, further including a first angle and a second angle wherein the first angle is formed by the intersection of the first point and the fold, and the second angle is formed by the intersection of the second point and the fold.

13. The stealth craft of claim 12, wherein the first and second angles are acute angles.

14. The stealth craft of claim 11, wherein the stealth craft is an aircraft, the aircraft including a main wing.

15. The stealth craft of claim 14, wherein the main wing includes an outer edge that forms at least a portion of the first outer edge section.

16. The stealth craft of claim 14, further including a nose wing having an outer edge wherein the outer edge of the nose wing forms at least a portion of the second outer edge section.

17. The stealth craft of claim 14, further including a stabilizer having an outer edge, the outer edge of the stabilizer forming at least a portion of the second outer edge section.
